(19) United States
(12) Patent Application Publication
(10) Pub. No.: US 2006/0093436 A1
(43) Pub. Date: May 4, 2006

(54) PIPE LINER EVERSION APPARATUS WITH ROLLER SEAL

(76) Inventor: Stephen V. Gearhart, Hudson, IA (US)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 10/904,197

(22) Filed: Oct. 28, 2004

(51) Int. Cl. E21D 11/00; F16L 55/18

(52) U.S. Cl. 405/184.2; 405/184.1; 405/150.1

(57) ABSTRACT

An apparatus for use in installing a liner into a conduit as part of a repair procedure. The apparatus having a chamber which contains positive pressure to advance the liner into the conduit, a sealing inlet opening for feeding the pipe liner into the chamber without allowing positive pressure to escape from the chamber, and an exit opening through which the liner exits the chamber and advances into the conduit. The sealing inlet opening comprises a movable roller assembly and a rubber slot gasket communicating with the chamber and both sides of the pipe liner as the liner advances through the apparatus. One end of the liner is anchored at one end of the conduit and folded back over itself so as to create a pocket in the liner. Pressure is applied into the pocket which acts on the liner to evert it into the conduit.

### BACKGROUND OF THE INVENTION

This invention relates to pipe liner installation, and more particularly to a pipe liner eversion apparatus which uses pressure to evert a pipe liner into a conduit and has a roller means for sealing pressure inside the apparatus as the pipe liner moves through the apparatus and into the conduit.

It is well known that conduits or pipelines, particularly underground pipes, frequently require repair due to fluid leakage. The leakage may be inward from the environment into the interior of the pipelines. Alternatively, the leakage may be outward from the interior portion of the pipeline into the surrounding environment. In either case, it is desirable to avoid this leakage.

The leakage may be due to improper installation of the original pipe, or deterioration of the pipe itself due to normal aging or to the effects of conveying corrosive or abrasive material. Cracks at or near pipe joints may be due to environmental conditions such as earthquakes or the movement of large vehicles on the overhead surface, or other such causes. Regardless of the cause, such leakages are undesirable and may result in waste of the fluid being conveyed within the pipeline, or result in damage to the surrounding environment and possible creation of a dangerous public health hazard. If the leakage continues it can lead to structural failure of the existing conduit due to loss of soil and side support of the conduit.

Because of ever increasing labor and machinery costs, it is increasingly more difficult and less economical to repair underground pipes by digging up and replacing the pipes. As a result, various methods had been devised for the repair of existing pipelines without the need to dig up the pipe. These new “trenchless” methods avoid the expense, hazard, and public inconvenience associated with digging up and replacing the pipes or pipe sections.

Trenchless pipeline rehabilitation processes are described in U.S. Pat. No. 4,009,063 (Wood), U.S. Pat. No. 4,064,211 (Wood), and U.S. Pat. No. 5,374,174 (Long Jr.), the contents of which are incorporated herein by reference. The processes described in these patents involve inserting a liner into an existing conduit using an eversion process. The eversion process requires the flexible pipe liner to be inside out before introduction into the conduit (relative to its final position inside the conduit). One end of the liner is anchored and folded right side out at one end of the conduit so as to create a pocket in the liner. As pressure is applied into the liner pocket, the liner everts into the conduit.

An illustrative although unrelated example is to place a plastic garbage bag into a garbage can, fold the top portion of the bag around the rim of the garbage can, and then force pressure into the inside of the garbage can. As can be imagined, this process would cause the garbage bag to turn inside out (evert) as it exited the top of the can.

Once the flexible liner is installed in place within the pipe, the liner is pressurized from within to force the liner radially outwardly to engage and conform to the interior surface of the pipe and to force some of the impregnated resin into any cracks within the walls of the pipe. The resin is then cured to form a relatively hard, tight fitting, rigid pipe lining which effectively seals any cracks and repairs any pipe or pipe joint deterioration to prevent further leakage either into or out of the pipe. The cured resin liner also serves to provide added structural support for the surrounding pipe. The pipe liner is a fully structural, stand-alone pipe once cured. The apparatus of the present invention and its manner of use will be here described in connection with the installation of a liner of the above type, but it will be appreciated that that is by way of exemplification only.

There are several methods known in the art for applying eversion pressure into flexible pipe liner. Many of these methods use a pressure chamber into which the pipe liner is fed, as discussed above. The pressure chamber has an opening for the insertion of the pipe liner; however, this opening must not allow pressure in the chamber to escape as the pipe liner is fed into the pressure chamber. Therefore, the opening must form a tight seal around the pipe liner as the pipe liner enters the pressure chamber, so as to minimize pressure loss from the chamber into the atmosphere.

Several patents disclose such a seal. U.S. Pat. No. 5,374,174 (Long Jr.) discloses a pair of bladders which maintain pressure inside the chamber as the pipe liner is fed into the pressure chamber. The bladders engage the pipe liner as it slides into the pressurized chamber. The bladders produce a seal between the pressurized compartment and the atmosphere while allowing the pipe liner to slide between them. Similarly, U.S. Pat. No. 6,390,795 (Waring et. al) discloses a pair of lips which contact the sides of the flattened pipe liner as it passes into the pressurized chamber. The problem with the '174 (Long Jr.) device and the '795 (Waring) devise is that a large amount of friction is produced between the pipe liner and the bladder/lips as the liner moves into the chamber. As the pressure in the chamber increases, the amount of pressure applied to the pipe liner by the bladders/lips increases proportionally. Therefore, if a user increases the amount of pressure in the chamber to speed up the eversion process, the pressure increases the friction on the liner and actually slows the pipe liner eversion while also causing longitudinal stretching of the liner. The friction also creates considerable strain on the pipe liner, which can adversely affect its quality and longevity.

Another problem with the prior art is that it is difficult to adjust the distance between the bladders/lips, which is desirable when different sizes of pipe liners are used. If the bladders/lips are spaced too far apart, then pressure escapes from the chamber, which leads to slow eversion of the pipe liner and inefficient use of energy. If the opening is too narrow, then too much friction is applied to the pipe liner as it passes between the bladder or lips, which causes slow eversion into the conduit and strain on the pipe liner.

Therefore, there is a need for an improved seal on a liner everting device which allows the flattened liner to enter the pressurized chamber without excessive friction applied to the pipe liner.

It is an object of the present invention to provide a seal for a pipe liner everting device that minimizes friction between the pipe liner and the pressure chamber, while maintaining maximum pressure inside the chamber.

It is further an object of the present invention to provide a seal for a pipe liner everting device which maximizes the speed at which a pipe liner can be everted into an existing conduit.

It is further an object of the present invention to provide a seal for a pipe liner everting device which is easily adjustable to maximize efficiency when using different sizes of pipe liners.

### SUMMARY OF THE INVENTION

The present invention provides a transportable apparatus for use in installing a flexible tubular pipe liner into a conduit for repair and rehabilitation purposes using an eversion process. The eversion process requires the flexible pipe liner to be inside out before introduction into the conduit because the process causes the liner to be everted as it is fed into the conduit. As is known in the art, liners for use with the present invention can be commercially obtained in their inside out configuration. One end of the liner is fed through the inside of the apparatus in its inside out configuration, and then anchored and sealed around the exit opening of the apparatus in its right side out configuration. Because the anchor end of liner is folded right side out after exiting the apparatus, at least a portion of the liner is folded back over itself which forms a pocket or cuff in the liner. Pressure is applied to the pocket which causes the liner to evert into the conduit. The non-everted liner travels inside the everted portion of the liner as the liner everts into the conduit.

The flexible pipe liner enters the apparatus through a sealing inlet opening and exits the apparatus through an exit opening. Between the inlet opening and the exit opening is a pressure chamber adapted for receiving positive pressure through a pressure inlet port. Pressure is applied into the pressure chamber which is in communication with the pocket of the liner, thereby causing the liner to evert out of the exit opening of the apparatus and into the conduit.

The sealing inlet opening of the apparatus has a first pair of rollers for admitting the flattened liner into the pressurized chamber without significant loss of pressure. The rollers are combined with the pressure chamber so that the spacing between the rollers defines the pipe liner inlet opening. The distance between the rollers approximates the thickness of the flattened pipe liner as it enters the chamber. This allows the pipe liner to enter the pressurized chamber through the rubber slot gasket and between the rollers in a flattened configuration without allowing the positive pressure inside the chamber to escape into the atmosphere through the inlet opening. One or both of the rollers is/are combined with an adjustment means so that the distance between the rollers may be increased or decreased. The roller adjustment means is desirable because the optimum spacing between the rollers may change depending on the type and thickness of pipe liner being used.

In addition to the first pair of rollers described above, the present invention comprises at least a second pair of rollers on the outside of the chamber through which the pipe liner passes before entering the pressure chamber through the inlet opening. The second pair of rollers helps to properly align the liner by keeping it flat as it enters the chamber through the inlet opening which reduces friction between the pipe liner and the first pair of rollers.

The rollers of the present invention are advantageous over the prior art because they are fixed to the pressure chamber so that their position relative to the pressure chamber is not effected by the amount of pressure inside the chamber, as is the case with the bladders/lips described in the “Background” section of this specification. Tests have shown that devices currently known in the art are capable of inserting about 350 feet per hour of pipe liner into a conduit. The device of the present invention is capable of inserting about 6,000 feet per hour of pipe liner into a conduit.

### BRIEF DESCRIPTION OF THE DRAWING

FIG. 1 is a perspective view of the transportable liner eversion and installation apparatus in accordance with the present invention;

FIG. 2 is a side elevational view of the present invention with the outer covering cut away so as to show the interior components, including the sealing inlet rollers;

FIG. 3 is a perspective view looking from the pressure chamber out the inlet opening showing the sealing rollers;

FIG. 4 is a perspective view illustrating the manner in which the present invention may be used to install a pipe liner into a conduit;

FIG. 5 is a perspective view of the top portion of present invention showing the outside rollers, the roller adjustment means, and the pressure gauge;

FIG. 6 is a perspective view of the slot gasket; and

FIG. 7 is a perspective view of the retainer plate.

### DESCRIPTION OF THE PREFERRED EMBODIMENT OF THE INVENTION

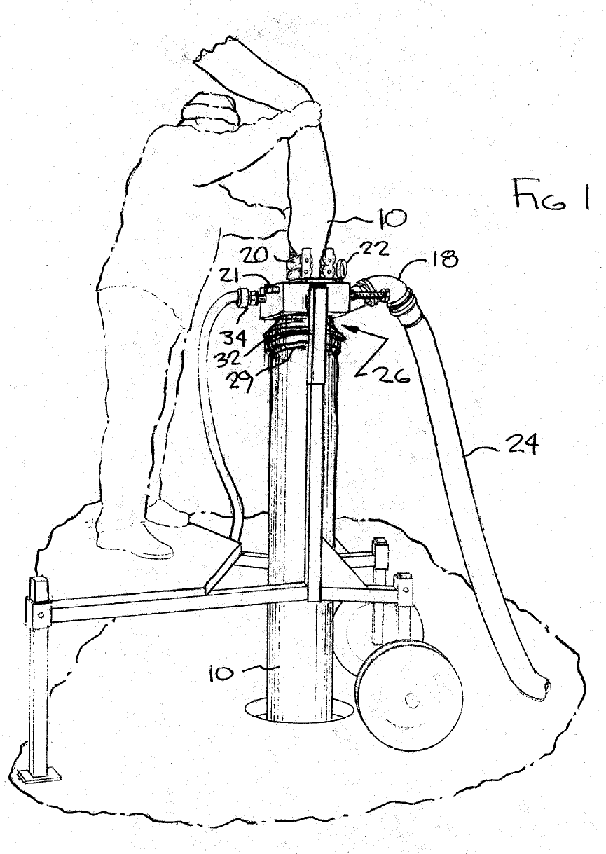

As seen generally in FIGS. 1, 2, and 4, the present invention provides a transportable apparatus for use in installing a flexible tubular pipe liner 10 into a hollow conduit 30 for repair purposes. The apparatus generally comprises a pressure chamber 26, a sealing inlet opening 28 with rollers 12, a liner exit opening 29, and a pressure inlet port 18.

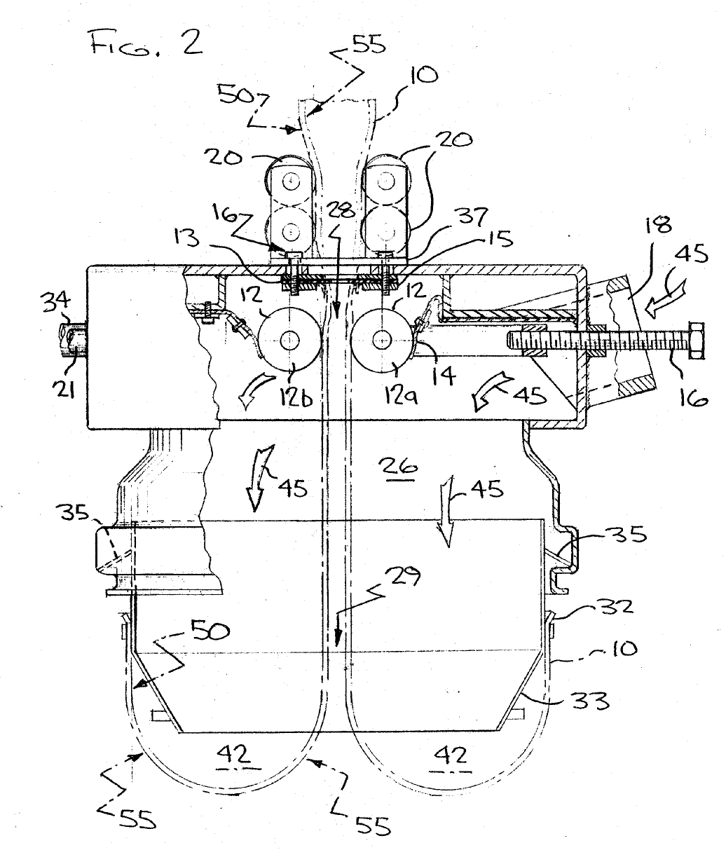

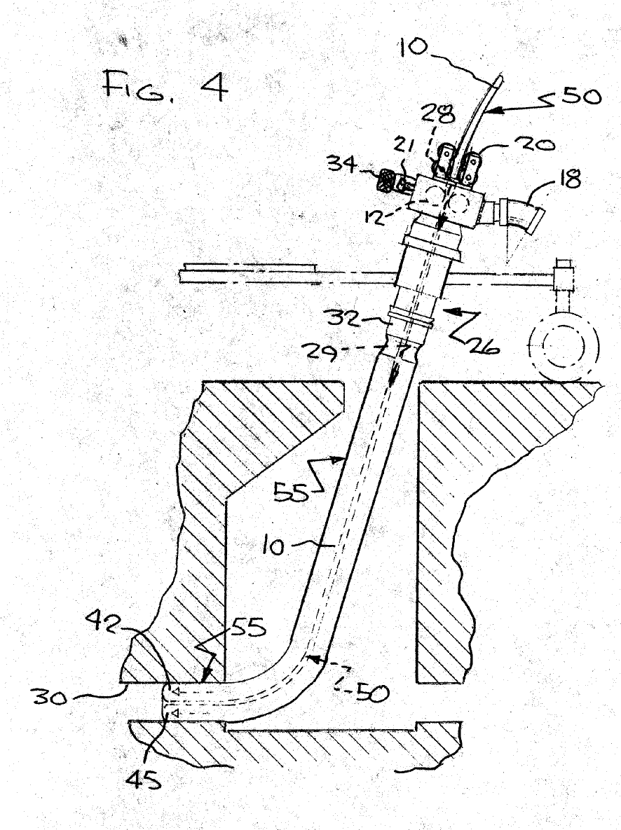

FIGS. 2 and 4 show the proximal end of the liner 10 fed through the apparatus in its inside out configuration. The inside of the liner 10 (relative to its final position inside of the conduit 30) is indicated by reference numeral 50, and the outside of the liner 10 which will be in contact with the conduit 30 is indicated by reference numeral 55. The eversion of the liner 10 is best seen in FIG. 2, wherein non-everted liner 10 enters through the inlet opening 28 with the inside 50 of the liner 10 facing outward. After the liner 10 has exited the apparatus, the inside 50 of the liner 10 everts and is facing inward. A pocket 42 is created in the liner 10 as the liner 10 everts.

As shown in FIG. 2, the proximal or anchor end 32 of the liner 10 is first fed through the apparatus and is anchored near the exit opening 29. In the preferred embodiment, the exterior portion of the exit opening 29 provides an anchor for securing the anchor end 32 of the liner 10 and providing an airtight seal around the exit opening 29. Because not all liners 10 are the same size, a liner size adapter 33 is preferably used at the exit opening 29 of the device to allow for various sized liners 10 to securely anchor to the device and provide a seal at the exit opening 29. In the preferred embodiment, the anchor end 32 of the liner 10 is combined with the size adapter 33 using a standard clamp (not shown). To ensure a seal between at the exit opening 29 when using a liner size adapter 33, a lip seal 35 is used between the wall of the device and the size adapter 33. Liner size adapters 33 and lip seals 35 are known in the industry. At the anchor end 32, the proximate end of the liner 10 is folded back, which forms a cuff or pocket 42 in the liner 10 that creates the pressure chamber 26. Pressure is introduced into the pressure chamber 26 through the pressure port 18 and into the pocket 42, as is shown by arrows 45. With the anchor end 32 of the liner 10 secured around the exit opening 29, the pressure 45 causes the liner 10 to evert out of the exit opening 29 (or liner size adapter 33) where it can then be directed into a nearby conduit 30. As seen in FIG. 4, the pocket 42 in the liner 10, and corresponding pressure 45 acting on the pocket 42, extends further into the conduit 30 as more of the liner 10 everts into the conduit 30. As the liner 10 everts into the conduit 30, the distal end of the non-everted liner 10 advances into the chamber 26 through the inlet opening 28.

As the liner 10 moves through the chamber 26, it is desirable to maximize the pressure inside the chamber 26 while minimizing the amount of friction on the liner 10 as the liner 10 passes through the chamber 26. As best shown in FIG. 2, a seal is created at the inlet opening 28 between a pair of rollers 12 and the non-everted liner 10. In the preferred embodiment, the rollers 12 are located near the inside of the chamber's 26 inlet opening 28. The rollers 12 allow the pipe liner 10 to move into the chamber 26 with a low amount of friction, while also producing a seal which keeps the eversion pressure from escaping into the atmosphere through the inlet opening 28. The rollers 12 are adapted to rotate on their longitudinal axis to minimize friction on the liner 10 as the liner 10 moves between them.

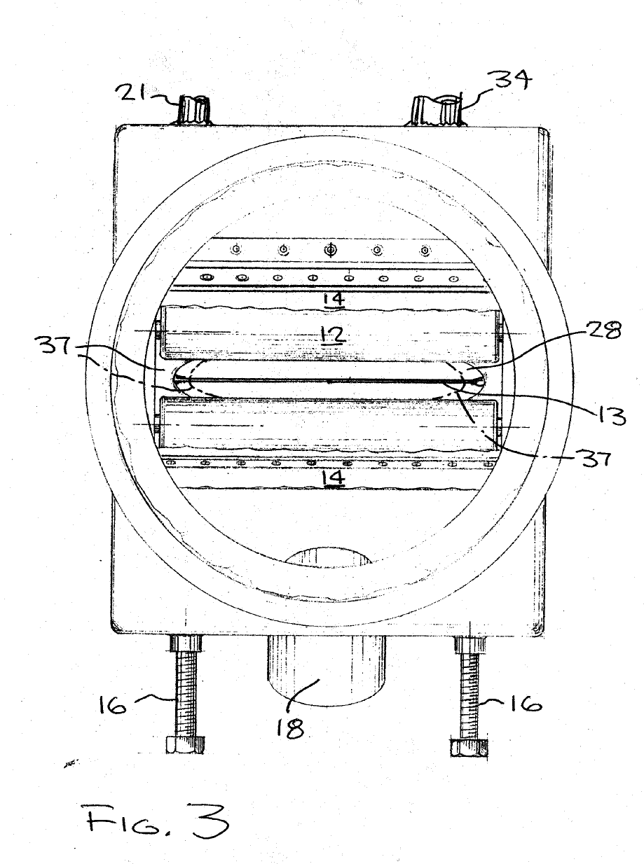

As seen in FIG. 3, the rollers 12 are combined with the pressure chamber 26 so that the distance between the rollers 12 (which defines the inlet opening 28) does not change in relation to the amount of pressure inside the chamber 26. Preferably, the distance between the rollers 12 is slightly larger than the thickness of the pipe liner 10 as it enters the pressure chamber 26. This allows the pipe liner 10 to advance into the pressurized chamber 26 in a generally flattened configuration with a low amount of friction without allowing the positive pressure inside the chamber 26 to escape into the atmosphere through the inlet opening 28. The rollers 12 are preferably comprised of a solid metal or plastic material so that their size and density is not noticeably affected by the amount of pressure inside the pressure chamber 26.

As seen in FIG. 2, at least one of the rollers 12 is combined with an adjustment mechanism 16 for adjusting the distance between the rollers 12. The roller adjustment mechanism 16 is desirable because the optimum spacing between the rollers 12 may change depending on the type and thickness of pipe liner 10 being used. In the preferred embodiment, an adjustable roller 12a is combined with a shaft 16 or bolt that extends from the adjustable roller 12a to the outside of the pressure chamber 26. Movement of this shaft 16 toward or away from the stationary roller 12b changes the respective distance between the rollers 12. The rollers 12 are combined with a flexible curtain means 14, which is comprised of leather in the preferred embodiment. As shown in FIG. 2, the flexible curtain means 14 connects the rollers 12 and the pressure chamber 26 to prevent pressure leakage around the rollers 12. The curtain means 14 is flexible enough to allow movement of the adjustable roller 12a while still maintaining a seal between the rollers 12 and pressure chamber 26.

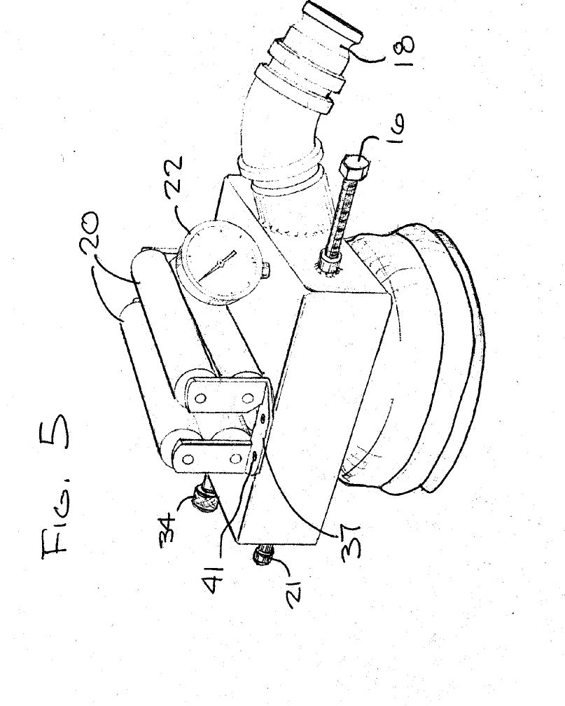

As discussed in the previous paragraph, the rollers 12 are adjustable with respect to the thickness of the liner 10 as it enters the pressure chamber 26 through the inlet opening 28. As seen in FIGS. 3 and 5, the device also comprises an adjustable plate 37 which adjusts the length of the inlet opening 28 to accommodate different sized liners. The adjustable plate 37 can be locked into place using any suitable means, however, the preferred means is a pair of set screws 41. As with the adjustable roller 12 mechanism described above, the adjustable plate 37 is necessary to ensure the inlet opening 28 is generally the same size as the liner 10 so as to minimize the escape of pressure out of the inlet opening 28.

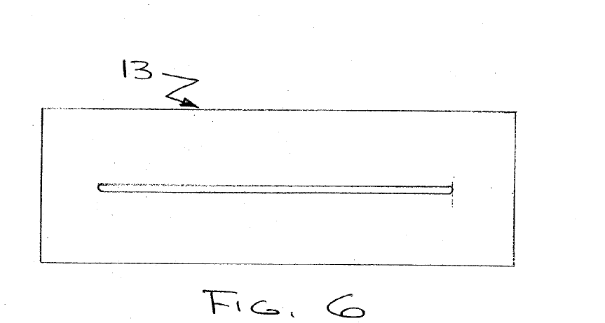

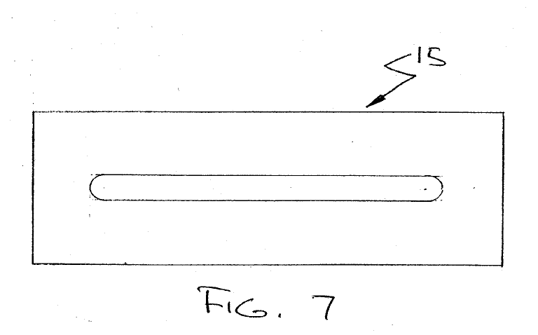

As seen in FIGS. 2 and 6, the inlet opening 28 further comprises a slot gasket 13 to aid the rollers 12 in creating a seal at the inlet opening 28. The slot gasket 13 is preferably combined with the top portion of the pressure chamber 26. Although the slot gasket 13 can be made of any suitable material, the preferred material is EPDM (Ethylene propylene diene terpolymer) rubber. The slot gasket 13 has a narrow longitudinal gap that runs parallel to the rollers 12. The size of the gap approximates the thickness of the liner 10 as it passes through the slot gasket 13. As seen in FIGS. 2 and 7, a retainer plate 15 is secured on top of the slot gasket 13 so as to prevent the flaps on the gasket 13 from blowing open when there is pressure in the pressure chamber 26. The retainer plate 15 is made of a sturdy material such as metal, and has an opening that is larger than the opening of the slot gasket 13. Different sized liners 10 may require slot gaskets 13 with different sized openings to ensure a tight seal around the liner 10.

As shown in FIG. 5, the pressure port 18 extends from the pressure chamber 26 and is adapted for connection to a pressure hose 24, which provides positive pressure to the pressure chamber 26 for everting the pipe liner 10. In a preferred embodiment of the present invention, a pressure gauge 22 is mounted on the exterior of the apparatus which provides a means for determining the amount of pressure inside the pressure chamber 26. The preferred embodiment also comprises a pressure relief mechanism 21. The pressure relief mechanism 21 is a safety device which releases the buildup of pressure inside the pressure chamber 26 when the pressure inside the chamber 26 reaches a predetermined level.

As best seen in FIG. 5, the present invention comprises at least one set of external rollers 20 in addition to the set of rollers 12 described above. The external rollers 20 are adapted to rotate on their longitudinal axis to minimize friction on the liner 10 as the liner 10 moves between them. The primary function of the external rollers is to prepare the liner 10 for proper insertion into the inlet opening 28. The external rollers 20 are beneficial because gas is often created inside the pipe liner 10 before it is used. This creation of gas causes the flexible pipe liner 10 to expand and consequently increase its diameter which can increase the friction between the pipe liner 10 and the internal rollers 12. The external rollers 20 reduce friction by compressing and aligning the pipe liner 10 so as to minimize friction and allow the pipe liner 10 to efficiently enter the pressure chamber 26 through rollers 12.

FIG. 1 shows a lubrication valve 34 combined with the apparatus for injecting lubricant onto the uneverted liner as it passes through the pressure chamber 26. The lubricant reduces friction on the non-everted liner 10 as it slides through the everted liner 10 and moves into its position within the conduit 30.

In use, the non-everted liner 10 passes through the external rollers 20 and enters the apparatus through the inlet opening 28. The non-everted liner 10 passes through the appropriately sized slot gasket 13, then through the internal rollers 12, and then into the interior of the pressure chamber 26. The pressure 45 inside the chamber 26 acts to evert and extend the liner 10 into the conduit 30. Once the pipe liner 10 has been completely everted to the far end of the conduit, the far end of the liner 10 can be sealed and contained as necessary so that pressure and heat in curing the liner 10. The resin on the liner 10 is cured to form a hard, tight fitting, rigid pipe lining 10 which effectively seals any cracks and repairs any pipe or pipe joint deterioration to prevent further leakage either into or out of the pipe 30.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

What is claimed is as follows:

1. An apparatus for everting a flexible tubular liner having a proximal end and a distal end as the liner is introduced into the interior of a hollow conduit comprising:
a pressure chamber having an inlet opening and an exit opening, wherein the distal end of the liner is adapted to enter the pressure chamber through the inlet opening and exit the pressure chamber through the exit opening as the liner is everted;
a first pair of rollers combined with the pressure chamber, one of the pair of rollers located on each side of the inlet opening to receive the liner to be everted so as to create a seal for preventing pressure in the pressure chamber from escaping through the inlet opening; and
a pressure inlet port through which pressure is introduced into the pressure chamber so that the pressure inside the chamber is greater than the ambient atmospheric pressure surrounding said pressure chamber, whereby said pressure everts the liner so that it can be introduced into the conduit;
wherein the proximal end of the liner seals with the exit opening thereby forming the pressure chamber.

2. (canceled)

3. The apparatus of claim 1 wherein the distance between the first pair of rollers is adjustable so as to maintain the seal when liners of different sizes are used.

4. The apparatus of claim 3 in which the seal further comprises a flexible curtain in communication with the pressure chamber and each of the first pair of rollers, said flexible curtain being movable as the distance between the rollers changes.

5. The apparatus of claim 3 wherein the distance between the first pair of rollers is approximately the same as the thickness of the non-everted liner.

6. The apparatus of claim 1 further comprising a second pair of rollers upstream from the inlet opening of the pressure chamber.

7. The apparatus of claim 1 further comprising a lubrication injection port for injecting lubrication onto the liner.

8. The apparatus of claim 1 further comprising a pressure gauge for determining the pressure inside the pressure chamber.

9. The apparatus of claim 1 further comprising an adjustable plate near the inlet opening upstream from the first pair of rollers, said adjustable plate for adjusting the length of the inlet opening.

10. The apparatus of claim 1 further comprising a slot gasket combined with the inlet opening.

11. The apparatus of claim 1 further comprising a liner size adapter combined with the exit opening.

12. A method of installing a flexible pipe liner into a hollow conduit using a pipe liner eversion apparatus having a pressure chamber, an inlet opening into the pressure chamber with a roller seal, and an exit opening from the pressure chamber, said method comprising:
inserting a first end of non-everted liner into the inlet opening between the rollers so as to create a seal at the inlet opening, through the pressure chamber, and out the exit opening;
anchoring the first end of the liner to the apparatus near the exit opening;
introducing pressure into the pressure chamber thereby causing the liner to continuously evert out the exit opening as non-everted liner continues to enter the apparatus through the inlet opening; and
introducing the everted liner into the hollow conduit.

13. The method of claim 12 further comprising the step of setting the rollers a predetermined distance apart from each other so that the liner will enter the pressure chamber by advancing through the rollers, with a minimal amount of pressure while preventing escape of pressure between the rollers and out of the inlet opening.

14. An apparatus for everting a flexible tubular liner having a proximal end and a distal end as the liner is introduced into the interior of a hollow conduit, the apparatus comprising:
a pressure chamber having an inlet opening and an exit opening, wherein the distal end of the liner is adapted to enter the pressure chamber through the inlet opening and exit the pressure chamber through the exit opening as the liner is everted;
a first pair of rollers combined with the pressure chamber, one of the pair of rollers located on each side of the inlet opening to receive the liner to be everted;
a means for creating a seal at the inlet opening using the first pair of rollers so as to prevent pressure in the pressure chamber from escaping through the inlet opening; and
a pressure inlet port through which pressure is introduced into the pressure chamber so that the pressure inside the chamber is greater than the ambient atmospheric pressure surrounding said pressure chamber, whereby said pressure everts the liner so that it can be introduced into the conduit;
wherein the proximal end of the liner seals with the exit opening thereby forming the pressure chamber.
